(19) United States
(12) Patent Application Publication
(10) Pub. No.: US 2017/0283542 A1
(43) Pub. Date: Oct. 5, 2017

(54) FLAME RETARDANT SLABSTOCK POLYURETHANE FOAM COMPOSITION

(71) Applicants: Hyundai Motor Company, Seoul (KR); KUMHO CHEMICAL INDUSTRY LTD., Siheung-si (KR)

(72) Inventors: Kwon Yong CHOI, Seoul (KR); Soon Joon JUNG, Seoul (KR); Do Young KIM, Seoul (KR)

(73) Assignees: Hyundai Motor Company, Seoul (KR); KUMHO CHEMICAL INDUSTRY LTD., Siheung-si (KR)

(21) Appl. No.: 15/295,872

(22) Filed: Oct. 17, 2016

(30) Foreign Application Priority Data
Mar. 30, 2016 (KR) 10-2016-0038069

(51) Int. Cl. C08G 18/08; C08J 9/00; C08G 18/16; C08G 18/48; C08G 18/76

(52) U.S. Cl. CPC C08G 18/14; C08G 18/4804; C08G 18/7621; C08G 18/165; C08J 9/0061; C08G 18/7607; C08J 2375/08; C08J 2471/02; C08G 2101/0083

(57) ABSTRACT

A flame retarded slabstock polyurethane foam composition including polyol and polyisocyanate as main materials, and an additive for forming a general polyurethane foam except for a flame retarded agent, in which the polyol may be polyether polyol and may include 10 to 45 wt % of polyether polyol (A) having a weight-average molecular weight of 2,000 to 5,000 g/mol and 55 to 90 wt % of polyether polyol (B) having a weight-average molecular weight of 600 to 1,500 g/mol, and an isocyanate index of the composition defined by Equation 1 may be in a range of 70 to 95, and Equation 1 may be Isocyanate index=mole of isocyanate group (NCO)/mole of hydroxyl group (OH)×100.

### CROSS-REFERENCE TO RELATED APPLICATION

The present application claims priority to Korean Patent Application No. 10-2016-0038069, filed Mar. 30, 2016, the entire contents of which is incorporated herein for all purposes by this reference.

### BACKGROUND OF THE INVENTION

### Field of the Invention

The present invention relates to a flame retardant slabstock polyurethane foam composition which has flame retarded performance itself and does not require a separate flame retardant additive.

### Description of Related Art

A soft polyurethane foam has good mechanical strength (e.g., elongation, tensile strength, and abrasion resistance) as well as good permeability and cushion due to an open cell structure, and thus it has been widely used in all fields of industry such as components of vehicle, electrical, and electronic products or household goods.

The soft polyurethane foam is classified into a slabstock foam and a mold foam according to a production method. The slabstock foam refers to a foam used by cutting the freely foamed and cured foam in a desired form without injecting a raw liquid into a mold.

Since the slabstock polyurethane foam is frequently used as an interior material, being flame retardant is one of the important required properties. In the case of the polyurethane foam applied to the interior, in order to delay burning time in case of fire and reduce the amount of gas caused by the combustion, the flame retardant performance is regulated.

Methods of enhancing the flame retardant performance of polyurethane foam include separately adding a flame retardant additive, and using a flame retardant raw material in which a flame retardant element such as phosphorus, nitrogen, or halogen is chemically bonded to polyol or isocyanate.

In general, the method of adding a flame retardant additive has been frequently used to enhance the flame retardant performance of polyurethane foam. For example, a slabstock polyurethane foam composition containing polyol and toluene diisocyanate (TDI) as main materials and including various additives such as a flame retardant agent, a catalyst, a foaming agent, and the like have been disclosed. However, most flame retardant agents are easily scattered at a high temperature conditions due to their small molecular weight. In the case of halogen-containing flame retardant agents, it was reported that dioxine, a carcinogen, is generated during combustion. Therefore, the use of the halogen-based flame retardant agents has been regulated.

Accordingly, there remains a need for slabstock polyurethane foam compositions that have self-flame retardant properties and do not include separately added flame retardant additives.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a novel flame retardant slabstock polyurethane foam composition having self-flame retardant properties without using flame retardant additives.

Additionally, various aspects of the present invention are directed to providing a soft polyurethane foam having a flame-retardant property.

According to various aspects of the present invention, a flame retardant slabstock polyurethane foam composition may include polyol and polyisocyanate as main materials, and an additive for forming a general polyurethane foam and not a flame retardant agent, wherein the polyol may be polyether polyol and include 10 to 45 wt % of polyether polyol A having a weight-average molecular weight of 2,000 to 5,000 g/mol and 55 to 90 wt % of polyether polyol B having a weight-average molecular weight of 600 to 1,500 g/mol. The composition may have an isocyanate index of the composition of a range of 70 to 95, as defined by the following equation: isocyanate index =amount in moles of isocyanate group (NCO)/amount in moles of hydroxyl group (OH)×100.

The flame retardant slabstock polyurethane foam composition may include:100 parts by weight of polyether polyol, 30 to 120 parts by weight of polyisocyanate, 0.01 to 2 parts by weight of an amine-based catalyst, 0.01 to 2 parts by weight of a silicon-based foam stabilizer, 1 to 5 parts by weight of a foaming agent, and 1 to 20 parts by weight of a cell opener.

The polyether polyol may be bio polyether polyol induced from vegetable oil.

The polyisocyanate may be selected from the group consisting of toluene diisocyanate (TDI), diphenylmethane diisocyanate (MDI), and polydiphenylmethane diisocyanate (DPMDI).

According to various aspects of the present invention, a soft polyurethane foam having a density of 30 to 100 kg/m³ and a flame retardant property is prepared using a flame retardant slabstock polyurethane foam composition. The flame retardant slabstock polyurethane foam composition may include polyol and polyisocyanate as main materials, and an additive for forming a general polyurethane foam, and not a flame retardant agent, wherein the polyol may be polyether polyol and includes 10 to 45 wt % of polyether polyol A having a weight-average molecular weight of 2,000 to 5,000 g/mol and 55 to 90 wt % of polyether polyol B having a weight-average molecular weight of 600 to 1,500 g/mol. The composition may have an isocyanate index of the composition of a range of 70 to 95 as defined by the following equation:iIsocyanate index amount in moles of isocyanate group (NCO)/amount in moles of hydroxyl group (OH)×100.

In various aspects, the present invention provides a soft polyurethane foam prepared by foaming the composition and having a density of 30 to 100 kg/m³ and a flame retardant property.

According to various embodiments of the present invention, the foam composition uses polyether polyol as a base component and is environmentally friendly since a separate flame retardant agent is not added to the composition.

The foam composition of the present invention has flame retardant properties itself and thus does not need the addition of a separate flame retardant agent, thereby solving any problems of property deterioration caused by including such an additive.

The foam composition of the present invention is not limited to toluene diisocyanate (TDI) as a polyisocyanate component, and may include diphenylmethane diisocyanate (MDI), poly-diphenylmethane diisocyanate (PMDI), and the like.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuel derived from resources other than petroleum). As referred to herein, a hybrid vehicle is a vehicle that has two or more sources of power, for example, both gasoline-powered and electric-powered vehicles.

The compositions, methods and apparatuses of the present invention have other features and advantages which will be apparent from or are set forth in more detail in the accompanying drawings, which are incorporated herein, and the following Detailed Description, which together serve to explain certain principles of the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Various embodiments of the present invention relate to a flame retardant slabstock polyurethane foam composition. In some embodiments, the flame retarded slabstock polyurethane foam composition of the present invention is formed by using polyol and polyisocyanate as main materials and including other generally used additives without using a flame retardant agent for forming the polyurethane foam.

Respective components forming the flame retardant slabstock polyurethane foam composition of the present invention will be described below in more detail.

(1) Polyol

In the present invention, polyether polyol is used as a polyol component, and polyether polyols having different molecular weight ranges are mixed and used at an appropriate ratio.

The polyether polyol may be bio polyether polyol derived from petroleum or vegetable oil, and the present invention is not particularly limited to the selection thereof. In some cases, the bio polyether polyol derived from the vegetable oil is commercially available, and in the present invention, a newly commercialized product may be used. In some cases, it may be preferable in terms of environmental compatibility to use waste oil.

The polyol uses a mixture of polyether polyol A having a weight-average molecular weight of 2,000 to 5,000 g/mol and polyether polyol B having a weight-average molecular weight of 600 to 1,500 g/mol. Preferably, the polyol uses a mixture of 10 to 45 wt % of the polyether polyol A and 55 to 90 wt % of the polyether polyol B.

In the configuration of the mixture of the polyol, when the content of the polyether polyol A having the weight-average molecular weight of 2,000 to 5,000 g/mol is less than 10 wt %, the hardness of the product is rapidly increased, and thus it is difficult to adjust the properties and shrinkage easily occurs. When the content thereof is greater than 45 wt %, the product may not maintain the flame retardant property, and thus it is important to appropriately adjust the mixed ratio of the polyether polyols A and B.

(2) Polyisocyanate

In flame retardant polyurethane foam compositions in the related art, toluene diisocyanate (TDI) is mainly used as a polyisocyanate component, but in the present invention, a selection range of the polyisocyanate is extended. In the present invention, known compounds which are widely used to those skilled in the art are used as the polyisocyanate component. In detail, the present invention includes a polyisocyanate component such as, but not limited to, aliphatic, cycloaliphatic, araliphatic, aromatic and hetero-cyclic polyisocyanates. Further, non-modified polyisocyanates or modified polyisocyanates may be used.

Particularly, the polyisocyanates may include methylene diisocyanate, ethylene diisocyanate, 1,4-tetramethylene diisocyanate, 1,6-hexamethylene diisocyanate, 1,12-dodecane diisocyanate, cyclobutane-1,3-diisocyanate, cyclohexane-1,3-diisocyanate, cyclohexane-1,4-diisocyanate, isophorone diisocyanate, 2,4-hexahydro-toluene diisocyanate, 2,6-hexahydro-toluene diisocyanate, dicyclohexylmethane-4,4icularly, the polyis), 1,3-phenylene diisocyanate, 1,4-phenylene diisocyanate, 2,4-toluene diisocyanate, 2,6-toluene diisocyanate, diphenylmethane-2,4isocyanate, diphenylmethanenylene diisocyanate, 2,4-toluene diisocyanate, 2,6-toluenate, 1,4-tetramethylene diisocyanate, triphenylmethane-4,4ne4yanate, triphenylmethane-4,4nenylene diisocyanate, 2,4-toluene diisocyanate, or any combination of two or more thereof.

Preferably, the polyisocyanate may use one or more kinds selected from the group consisting of 2,4-toluene diisocyanate, 2,6-toluene diisocyanate, diphenylmethane-2,4′-diisocyanate, diphenylmethane-4,4′-diisocyanate, and polydiphenylmethane diisocyanate.

Further, the content of the polyisocyanate may be limited to an isocyanate index range of the polyurethane foam composition. The isocyanate index may be defined by the following equation:

Isocyanate index=mole of isocyanate group (NCO)/mole of hydroxyl group (OH)×100

Generally, in the field for the polyurethane foam, a ratio of moles (amount in moles) of an isocyanate group (NCO) to moles (amount in moles) of a hydroxyl group (OH) is set as an excess amount of NCO residue in the polyurethane foam. That is, in the related art, the isocyanate index by the equation above is set at 100 or more, particularly, 110 to 130.

However, the present invention is characterized by adjusting the isocyanate index as defined by the equation above to a range of 70 to 95. In the present invention, the isocyanate index may be defined by the ratio of moles (amount in moles) of the isocyanate group to moles (amount in moles) of the hydroxyl group present in the foam composition. The moles (amount in moles) of the isocyanate group may be determined by the content of polyisocyanate and the moles (amount in moles) of the hydroxyl group may be determined by the content of additives having a hydroxyl group such as water which can be used as a foaming agent, in addition to the polyol.

In the foam composition of various embodiments of the present invention, the polyisocyanate index as defined by the equation provided herein may be maintained to 70 to 95 in the flame retardant slabstock polyurethane foam composition. When the isocyanate index is less than 70, the content of NCO of the composition is too small and the yield of the polyurethane foam is decreased. , When the isocyanate index is greater than 95, the flame retardant property rapidly deteriorates.

In order to satisfy the isocyanate index parameters, the polyisocyanate may be used in a range of 30 to 120 parts by weight based on 100 parts by weight of polyol. When the content of the polyisocyanate is less than 30 parts by weight, the isocyanate index may be less than 70 and when the content thereof is greater than 120 parts by weight, the isocyanate index may be greater than 95.

(3) Additive

In various embodiments of the present invention, an additive for forming a general polyurethane foam may be included. In various embodiments of the present invention, the polyurethane foam itself is sufficiently flame retardant, and a separate flame retardant agent need not be added. If a flame retardant agent is added to the polyurethane foam composition of the present invention, the flame retardant agent may cause environmental risk and deterioration of basic properties of the foam composition, and thus the flame retardant agent should not be added. However, if necessary, a flame retardant agent may be added in a small amount within a range that does not affect the properties of the foam.

The additive included in the composition of the present invention may include one or more kinds selected from of a catalyst, a cross-linking agent, a foam stabilizer, a foaming agent, a cell opener, and the like. The additive may be appropriately selected within a range of 0.001 to 20 parts by weight, preferably, 0.01 to 10 parts by weight based on 100 parts by weight of the polyol.

An additive component which may be included in the polyurethane foam composition of various embodiments of the present invention will be described below in detail.

The catalyst serves to facilitate a reaction between the polyol and the isocyanate compound. The catalyst may use one or more catalysts selected from tertiary amine catalysts including triethylene diamine, triethyl amine, n-methyl morpholine, n-ethyl morpholine, and the like and organic tin catalysts including stannous octoate, dibutyltin dilaurae (DBTDL), and the like. The catalyst may be used in a range of 0.01 to 2 parts by weight, preferably 0.1 to 1 part by weight based on 100 parts by weight of the polyol. When the use amount of the catalyst is too small, the reaction is delayed and thus a cured defect is generated, and when the use amount thereof is too large, shrinkage or cracks in the foam may result.

When a cell is formed in the polyurethane foam, the foam stabilizer serves to prevent the generated cell from being consolidated or broken and adjust the cell having uniform shape and size to be formed. The foam stabilizer is generally used in the art and the present invention is not particularly limited, but a silicon-based foam stabilizer may be generally used. The silicon-based foam stabilizer may be one or more kinds selected from silicon oil, derivatives thereof, and the like, and particularly, a polyalkylene oxide methyl siloxane copolymer. The foam stabilizer may be used in a range of 0.01 to 2 parts by weight, preferably 0.1 to 1 part by weight based on 100 parts by weight of the polyol. In this case, when the use amount of the foam stabilizer is too small, the formation of the foam is non-uniform, and when the use amount thereof is too large, problems of foam shrinkage and loss of flame retardant properties can occur.

The foaming agent may be used by appropriately selecting a known foaming agent component used as a composition for a soft polyurethane foam body from the related art by considering various properties of the required foam. As the foaming agent, water may be representatively used, and in addition, the foaming agent may include one or more kinds selected from methylene chloride, n-butane, isobutane, n-pentane, isopentane, dimethyl ether, acetone, carbon dioxide, and the like. These foaming agents may be appropriately selected and used according to—known methods and required properties of the foam. Accordingly, in various embodiments of the present invention, the use amount of the foaming agent is not particularly limited, but if it should be limited, the foaming agent may be used in a range of 1 to 5 parts by weight based on 100 parts by weight of the polyol.

The cell opener may use polyether polyol. The cell opener is particularly obtained by addition-polymerizing ethylene oxide (EO) and propylene oxide (PO) and may use polyether polyol having a weight ratio of EO:PO of 50 to 80:20 to 50 wt %, a weight-average molecular weight of 3,000 to 8,000 g/mol, and an OH value of 20 to 60 mg KOH/g. The cell opener may use 1 to 20 parts by weight based on 100 parts by weight of the polyol. In this case, when the use amount of the cell opener is too small, the foam shrinks and thus the shape is not maintained, and when the use amount thereof is too large, collapse, cracks, and the like form in the foam.

Various embodiments of the present invention provide a soft polyurethane foam prepared by foaming the foam composition described above. The soft polyurethane foam having a light weight with the density of 30 to 100 kg/m³ is useful as interior materials of vehicles and the like.

As described above, the present invention will be described in more detail based on the following Examples, and the present invention is not limited to the following Examples.

### EXAMPLES

The following examples illustrate the invention and are not intended to limit the same.

Examples 1 to 12 and Comparative Examples 1 to 8

A polyol, a catalyst, a silicon-based foam stabilizer, a cell opener, and water were mixed according to components and content ratios represented in the following Tables 1 to 4 and sufficiently mixed for 1 to 3 min at a stirring speed of 3,000 rpm to prepare a polyol resin premix. Polyisocyanate was added in the mixture and stirred for 7 to 10 sec at a stirring speed of 3,000 rpm to prepare a sample. A polyethylene film was spread on a square box mold of 250 mm×250 mm in a square form and the sample was poured thereon. In this case, a cream time and a rise time were measured by using a stopwatch and recorded, and whether health bubbles were generated was observed. Curing was performed at room temperature.

Properties of the prepared foam specimen were measured by the following evaluation methods and the results thereof were illustrated in the following Tables 1 to 4, respectively.

[Method of Evaluating Properties]

(1) Molding density: Measured by KS-M-6672

(2) Tensile strength: Measured by KS-M-ISO-7214

(3) Elongation: Measured by KS-M-ISO-7214

(4) Combustibility: Measured by FMVSS-302

[Used Components]

1) Polyol component—GP-3000 Polyether polyol having weight-average molecular weight of 3,000, GP-3000 product of KPX Chemical Corp.

Polyether polyol having weight-average molecular weight of 700, SR-240 product of KPX Chemical Corp.

2) Polyisocyanate component

Toluene diisocyanate (2,4-/2,6-isomer ratio=80/20), Lupranate T-80 product of Korea BASF Corp.

Mixture of 80 wt % of diphenylmethane diisocyanate and 20 wt % toluene diisocyanate (2,4- /2,6-isomer ratio=80/20), 37.1 wt % of NCO content, Cosmonate CG-8020 of Kumho Mitsui Chemicals Corp.

Diphenylmethane diisocyanate, 30 wt % of NCO content, Cosmonate CG-3000 of Kumho Mitsui Chemicals Corp.

Diphenylmethane diisocyanate, 33 wt % of NCO content, Cosmonate CG-1033 of Kumho Mitsui Chemicals Corp.

3) Amine-based catalyst

Triethylene diamine/dipropylene glycol solution at 33 wt % concentration, TEDA L-33 of Tosoh Corp.

Bis-(2-dimethylaminoethyl) ether/propylene glycol solution at 70 wt % concentration, NIAX catalyst A-1 of Momentive Corp.

Tin octylate, U-28 of Nitto Kasei Co.

4) Silicon foam stabilizer

Polyalkylene oxide methyl siloxane copolymer, Niax silicone L-580K of Momentive Co., Ltd

Polyalkylene oxide methyl siloxane copolymer, Niax silicone L-626 of Momentive Co., Ltd

Polyalkylene oxide methyl siloxane copolymer, Niax silicone L-638 of Momentive Co., Ltd

5) Cell opener

Conix TA-350 of KPX Chemical Corp.

The following Table 1 lists the results of comparing properties of a polyurethane foam specimen using toluene diisocyanate (2,4-/2,6-isomer ratio=80/20) as polyisocyanate.

TABLE 1

| | | | Examples | | | Comparative Examples | |
|---|---|---|---|---|---|---|---|
| Classification | | | 1 | 2 | 3 | 1 | 2 |
| Composition | Polyol | GP-3000 | 40 | 40 | 40 | 80 | 40 |
| (parts by | | SR-240 | 60 | 60 | 60 | 20 | 60 |
| weight) | polyisocyanate | TDI-80 | 48.4 | 57.5 | 39.6 | 35.2 | 72.6 |
| | catalyst | TEDA | 0.2 | 0.2 | 0.4 | 0.2 | 0.05 |
| | | L-33 | | | | | |
| | | A-1 | 0.05 | 0.05 | 0.08 | 0.05 | 0.05 |
| | | U-28 | 0.13 | 0.13 | 0.09 | 0.13 | 0.13 |
| | Foam | L-580K | 0.6 | 0.6 | — | 0.6 | 0.6 |
| | stabilizer | L-626 | — | — | 0.5 | — | — |
| | | L-638 | — | — | 0.5 | — | — |
| | Cell opener | TA-350 | 4.0 | 4.0 | 4.0 | 4.0 | 4.0 |
| | Foaming agent | Water | 2.95 | 2.95 | 1.85 | 2.95 | 2.95 |

| | | | | | | |
|---|---|---|---|---|---|---|
| Properties | Isocyanate index | 80 | 95 | 80 | 80 | 120 |
| | Cream time (sec) | 14 | 12 | 15 | 13 | 10 |
| | Rise time (sec) | 100 | 95 | 110 | 105 | 85 |
| | Health bubbles | Presence | Presence | Presence | Presence | None |
| | Foam state | Good | Good | Good | Internal | Shrinkage |
| | | | | | tear | |
| | Density (kg/m³) | 34.3 | 34.8 | 47.9 | 34.7 | Immeasurable |
| | Tensile strength (kg/m²) | 1.4 | 1.45 | 1.3 | 0.8 | Immeasurable |
| | Elongation (%) | 180 | 195 | 140 | 105 | Immeasurable |
| | FMVSS-302 | Success | Success | Success | Failure | Failure |

In Table 1, specimens of Examples 1 to 3 were obtained by foaming a composition wherein the isocyanate index was adjusted to as low as 70 to 95 while mixing and using polyether polyol A having a weight-average molecular weight of 2,000 to 5,000 g/mol and polyether polyol B having a weight-average molecular weight of 600 to 1,500 g/mol as polyol components with an appropriate content ratio. In the specimens of Examples 1 to 3, the foam state was good and a sufficiently excellent flame retardant property was observed without the separate addition of flame retardant agent.

On the other hand, Comparative Example 1 was a specimen obtained by mixing, using, and foaming 80 wt % of polyether polyol A having a weight-average molecular weight of 2,000 to 5,000 g/mol and 20 wt % of polyether polyol B having a weight-average molecular weight of 600 to 1,500 g/mol as polyol components. In the specimen of Comparative Example 1, as the foam state, an internal tear phenomenon was seen and in the flame retardant test, failure was determined. Comparative Example 2 was a specimen obtained by foaming a composition wherein the isocyanate index was adjusted to as high as 130 and in the foam state, shrinkage was seen and in a flame retarded test, failure was determined.

The following Table 2 lists the results of comparing properties of a polyurethane foam specimen using a mixture of 80 wt % of diphenylmethane diisocyanate and 20 wt % of toluene diisocyanate (2,4-/2,6-isomer ratio=80/20) as polyisocyanate.

TABLE 2

| | | | Examples | | | Comparative Examples | |
|---|---|---|---|---|---|---|---|
| Classification | | | 4 | 5 | 6 | 3 | 4 |
| Composition | Polyol | GP-3000 | 40 | 40 | 40 | 80 | 40 |
| (parts by | | SR-240 | 60 | 60 | 60 | 20 | 60 |
| weight) | polyisocyanate | CG-8020 | 67.8 | 80.5 | 55.9 | 50.7 | 101.7 |
| | catalyst | TEDA | 0.4 | 0.4 | 0.6 | 0.4 | 0.15 |
| | | L-33 | | | | | |
| | | A-1 | 0.05 | 0.05 | 0.08 | 0.05 | 0.05 |
| | | U-28 | 0.01 | 0.01 | 0.01 | 0.01 | 0.01 |
| | Foam | L-580K | 0.3 | 0.3 | — | 0.3 | 0.3 |
| | stabilizer | L-626 | — | — | 0.3 | — | — |
| | | L-638 | — | — | 0.2 | — | — |
| | Cell opener | TA-350 | 4.0 | 4.0 | 4.0 | 4.0 | 4.0 |
| | Foaming agent | Water | 3.45 | 3.45 | 2.30 | 3.45 | 3.45 |

| | | | | | | |
|---|---|---|---|---|---|---|
| Properties | Isocyanate index | 80 | 95 | 80 | 80 | 120 |
| | Cream time (sec) | 14 | 12 | 15 | 12 | 10 |
| | Rise time (sec) | 100 | 95 | 110 | 120 | 90 |
| | Health bubbles | Presence | Presence | Presence | Presence | None |
| | Foam state | Good | Good | Good | Good | Shrinkage |
| | Density (kg/m³) | 36.2 | 35.4 | 53.1 | 36.1 | Immeasurable |
| | Tensile strength (kg/m²) | 1.3 | 1.2 | 1.4 | 1.15 | Immeasurable |
| | Elongation (%) | 170 | 150 | 115 | 140 | Immeasurable |
| | FMVSS-302 | Success | Success | Success | Failure | Failure |

As the experimental result of Table 2 was similar to Table 1, and as a result, according to the present invention, it can be seen that the selection of the polyisocyanate is not particularly limited.

The following Table 3 lists the results of comparing properties of a polyurethane foam specimen using diphenylmethane diisocyanate (30 wt % of NCO content) as polyisocyanate.

TABLE 3

| | | | Examples | | | Comparative Examples | |
|---|---|---|---|---|---|---|---|
| Classification | | | 7 | 8 | 9 | 5 | 6 |
| Composition | Polyol | GP-3000 | 40 | 40 | 40 | 80 | 40 |
| (parts by | | SR-240 | 60 | 60 | 60 | 20 | 60 |
| weight) | polyisocyanate | CG-3000 | 83.8 | 99.6 | 69.0 | 62.7 | 125.8 |
| | catalyst | TEDA | 0.4 | 0.4 | 0.6 | 0.4 | 0.15 |
| | | L-33 | | | | | |
| | | A-1 | 0.05 | 0.05 | 0.08 | 0.05 | 0.05 |
| | | U-28 | 0.01 | 0.01 | 0.01 | 0.01 | 0.01 |
| | Foam | L-580K | 0.1 | 0.1 | — | 0.1 | 0.1 |
| | stabilizer | L-626 | — | — | 0.3 | — | — |
| | | L-638 | — | — | 0.2 | — | — |
| | Cell opener | TA-350 | 4.0 | 4.0 | 4.0 | 4.0 | 4.0 |
| | Foaming agent | Water | 3.45 | 3.45 | 2.30 | 3.45 | 3.45 |

| | | | | | | |
|---|---|---|---|---|---|---|
| Properties | Isocyanate index | 80 | 95 | 80 | 80 | 120 |
| | Cream time (sec) | 12 | 10 | 14 | 14 | 8 |
| | Rise time (sec) | 105 | 100 | 120 | 118 | 90 |
| | health bubbles | Presence | Presence | Presence | Presence | None |
| | Foam state | Good | Good | Good | Good | Shrinkage |
| | Density (kg/m³) | 35.5 | 36.2 | 51.5 | 34.4 | Immeasurable |
| | Tensile strength (kg/m²) | 1.2 | 1.5 | 1.55 | 0.8 | Immeasurable |
| | Elongation (%) | 100 | 105 | 95 | 80 | Immeasurable |
| | FMVSS-302 | Success | Success | Success | Failure | Failure |

As the experimental result of Table 3 was similar to Table 1, and as a result, according to the present invention, it can be seen that the selection of the polyisocyanate is not particularly limited.

The following Table 4 lists the results of comparing properties of a polyurethane foam specimen using diphenylmethane diisocyanate (33 wt % of NCO content) as polyisocyanate.

TABLE 4

| | | | Examples | | | Comparative Examples | |
|---|---|---|---|---|---|---|---|
| Classification | | | 10 | 11 | 12 | 7 | 8 |
| Composition | Polyol | GP-3000 | 40 | 40 | 40 | 80 | 40 |
| (parts by | | SR-240 | 60 | 60 | 60 | 20 | 60 |
| weight) | polyisocyanate | CG-1033 | 76.2 | 90.5 | 62.8 | 62.7 | 114.3 |
| | catalyst | TEDA | 0.4 | 0.4 | 0.6 | 0.4 | 0.15 |
| | | L-33 | | | | | |
| | | A-1 | 0.05 | 0.05 | 0.08 | 0.05 | 0.05 |
| | | U-28 | 0.01 | 0.01 | 0.01 | 0.01 | 0.01 |
| | Foam | L-580K | 0.1 | 0.1 | — | 0.1 | 0.1 |
| | stabilizer | L-626 | — | — | 0.3 | — | — |
| | | L-638 | — | — | 0.2 | — | — |
| | Cell opener | TA-350 | 4.0 | 4.0 | 4.0 | 4.0 | 4.0 |
| | Foaming agent | Water | 3.45 | 3.45 | 2.30 | 3.45 | 3.45 |

| | | | | | | |
|---|---|---|---|---|---|---|
| Properties | Isocyanate index | 80 | 95 | 80 | 80 | 120 |
| | Cream time (sec) | 10 | 8 | 12 | 12 | 8 |
| | Rise time (sec) | 93 | 89 | 120 | 115 | 80 |
| | Health bubbles | Presence | Presence | Presence | Presence | None |
| | Foam state | Good | Good | Good | Good | Shrinkage |
| | Density (kg/m³) | 36.8 | 35.5 | 50.5 | 36.8 | Immeasurable |
| | Tensile strength (kg/m²) | 0.95 | 0.80 | 1.2 | 0.7 | Immeasurable |
| | Elongation (%) | 95 | 90 | 80 | 80 | Immeasurable |
| | FMVSS-302 | Success | Success | Success | Failure | Failure |

As the experimental result of Table 4 was similar to Table 1, and as a result, according to the present invention, it can be seen that the selection of the polyisocyanate is not particularly limited.

According to the above experimental results, in the related art, in order to prepare flame retardant polyurethane foam, toluene diisocyanate (TDI) is required, whereas according to the present invention, the polyisocyanate can include, in addition to toluene diisocyanate (TDI), diphenylmethane diisocyanate (MDI) and poly-diphenylmethane diisocyanate (PMDI).

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A flame retarded slabstock polyurethane foam composition, comprising:
polyol and polyisocyanate as main materials, and an additive for forming a general polyurethane foam and not a flame retardant agent, wherein the polyol is polyether polyol and includes 10 to 45 wt % of polyether polyol A having a weight-average molecular weight of 2,000 to 5,000 g/mol and 55 to 90 wt % of polyether polyol B having a weight-average molecular weight of 600 to 1,500 g/mol, and an isocyanate index of the composition of a range of 70 to 95 as defined by the following equation:
isocyanate index=amount in moles of isocyanate group (NCO)/amount in moles of hydroxyl group (OH)×100.

2. The flame retarded slabstock polyurethane foam composition of claim 1, comprising: 100 parts by weight of polyether polyol; 30 to 120 parts by weight of polyisocyanate; 0.01 to 2 parts by weight of an amine-based catalyst; 0.01 to 2 parts by weight of a silicon-based foam stabilizer; 1 to 5 parts by weight of a foaming agent; and 1 to 20 parts by weight of a cell opener.

3. The flame retarded slabstock polyurethane foam composition of claim 1, wherein the polyether polyol comprises bio polyether polyol induced from vegetable oil.

4. The flame retarded slabstock polyurethane foam composition of claim 1, wherein the polyisocyanate is selected from the group including toluene diisocyanate (TDI), diphenylmethane diisocyanate (MDI), and polydiphenylmethane diisocyanate (DPMDI).

5. A soft polyurethane foam having a density of 30 to 100 kg/m³ and a flame retardant property,
wherein the soft polyurethane foam is prepared from a flame retarded slabstock polyurethane foam composition comprising:
polyol and polyisocyanate as main materials, and an additive for forming a general polyurethane foam except for a flame retarded agent,
wherein the polyol is polyether polyol and includes 10 to 45 wt % of polyether polyol A having a weight-average molecular weight of 2,000 to 5,000 g/mol and 55 to 90 wt % of polyether polyol B having a weight-average molecular weight of 600 to 1,500 g/mol, and
an isocyanate index of a range of 70 to 95 as defined by the following equation:
isocyanate index=amount in moles of isocyanate group (NCO)/amount in moles of hydroxyl group (OH)×100.
